(19) United States
(12) Patent Application Publication
(10) Pub. No.: US 2025/0335490 A1
(43) Pub. Date: Oct. 30, 2025

(54) SYSTEMS AND METHODS FOR FACILITATING A DYNAMIC USER ENGAGEMENT WITH UNSTRUCTURED DATASETS

(71) Applicant: Thomas CZERNIAWSKI, North York (CA)

(72) Inventor: Thomas CZERNIAWSKI, North York (CA)

(21) Appl. No.: 19/191,715

(22) Filed: Apr. 28, 2025

Related U.S. Application Data
(60) Provisional application No. 63/639,924, filed on Apr. 29, 2024.

(51) Int. Cl. G06F 16/358; G06F 40/30

(52) U.S. Cl. CPC G06F 16/358; G06F 40/30

(57) ABSTRACT

Systems and methods of facilitating a dynamic user engagement with an unstructured dataset. The method involves operating a processor to: embed the unstructured dataset into a latent space to produce a plurality of vector representations reflective of one or more semantic relationships defined for one or more elements within the unstructured dataset; generate a set of reduced dimension vector representations from the plurality of vector representations by reducing the plurality of vector representations to the set of reduced dimension vector representations associated with one or more global semantic groupings defining one or more top hierarchical semantic relationships identified for the unstructured dataset and one or more local semantic groupings defining one or more sub-hierarchical semantic relationships for each top hierarchical semantic relationships; define one or more clusters for the set of reduced dimension vector representations, each cluster being associated with at least one global semantic grouping of the one or more global semantic groupings, at least one cluster having one or more sub-clusters with each sub-cluster being associated with at least one local semantic grouping in association with a corresponding global semantic grouping; and generate a dynamic visual representation for the one or more clusters according to a hierarchical structure defined for the unstructured dataset to facilitate the dynamic user engagement with the one or more elements of the unstructured dataset.

This application claims the benefit of U.S. Provisional Patent Application No. 63/639,924 filed on Apr. 29, 2024, entitled “Systems and Methods for Dynamic Visualization”. The entirety of U.S. Provisional Patent Application No. 63/639,924 is incorporated herein by reference.

### FIELD

The present disclosure is generally directed to systems and methods for facilitating a dynamic user engagement with unstructured datasets, such as providing adaptive visual representations responsive to user engagement inputs.

### BACKGROUND

Large datasets can provide valuable information but can be difficult to understand and interpret. As datasets grow increasingly large, heterogeneous, and multimodal due to advances in digital technologies, artificial intelligence, and the proliferation of internet-scale information sources, conventional visualization and data exploration methods struggle to remain effective and scalable.

Traditionally, large datasets are presented in spreadsheets, enumerated lists, or simple graphical formats. While these formats can be beneficial for users performing targeted operations such as sorting, filtering, or querying specific data attributes, they are poorly suited to exploratory navigation, discovery tasks, and domain overview. Many users approach large, complex datasets without explicit search intentions, instead seeking an initial understanding of the data's relevance, structure, and potential applications. This is especially common in contemporary settings such as technology conferences, online marketplaces, academic literature reviews, and complex enterprise knowledge bases and directories, where users frequently need intuitive methods for exploratory data interaction to derive actionable insights quickly. Consequently, there is an immediate and growing demand for practical visualization techniques and systems that facilitate intuitive, semantically meaningful, and scalable exploratory dataset discovery.

### SUMMARY

The various embodiments described herein generally relate to methods (and associated systems configured to implement the methods) for facilitating a dynamic user engagement with an unstructured dataset.

In accordance with an example embodiment, there is provided a method of facilitating a dynamic user engagement with an unstructured dataset. The method involves operating a processor to: embed the unstructured dataset into a latent space to produce a plurality of vector representations reflective of one or more semantic relationships defined for one or more elements within the unstructured dataset; generate a set of reduced dimension vector representations from the plurality of vector representations by reducing the plurality of vector representations to the set of reduced dimension vector representations associated with one or more global semantic groupings defining one or more top hierarchical semantic relationships identified for the unstructured dataset and one or more local semantic groupings defining one or more sub-hierarchical semantic relationships for each top hierarchical semantic relationships; define one or more clusters for the set of reduced dimension vector representations, each cluster being associated with at least one global semantic grouping of the one or more global semantic groupings, at least one cluster having one or more sub-clusters with each sub-cluster being associated with at least one local semantic grouping in association with a corresponding global semantic grouping; and generate a dynamic visual representation for the one or more clusters according to a hierarchical structure defined for the unstructured dataset to facilitate the dynamic user engagement with the one or more elements of the unstructured dataset.

In some embodiments, the method involves operating the processor to: receive an engagement input at the dynamic user engagement; automatically adapt the dynamic visual representation in response to the engagement input to vary at least one of: the one or more clusters or one and the more sub-clusters being displayed, a hierarchy level, and a semantic granularity of the dynamic visual representation; and continue to monitor for one or more engagement inputs for varying the dynamic visual representation.

In some embodiments receiving an engagement input at the dynamic user engagement further comprises operating the processor to receive a user query defining a desired topic; determine a relevance score between the user query and the elements within each cluster; and apply a heat map overlay to highlight clusters based on the relevance score.

In some embodiments, the method further involves automatically labelling each cluster and each sub-cluster using a topic modelling process.

In some embodiments, automatically labeling each cluster using a topic modelling process further comprises dynamically refining cluster labels in response to receiving additional elements.

In some embodiments, defining one or more clusters for the set of reduced dimension vector representations further comprises assigning for the one or more clusters and the one or more sub-clusters a stable orientation such that the relative association between adjacent clusters and adjacent sub-clusters are substantially preserved in response to receiving additional elements.

In some embodiments, in response to receiving additional elements, anchoring additional embedded elements to maintain an overall layout of the dynamic visual representation.

In some embodiments, generating a dynamic visual representation for the one or more clusters according to a hierarchical structure defined for the unstructured data further comprises generating a polygon-based representation for each cluster and each sub-cluster.

In some embodiments, the dynamic user engagement varies based on a user type.

In accordance with an example embodiment, there is provided a system of facilitating a dynamic user engagement with an unstructured dataset. The system includes a processor operable to: embed the unstructured dataset into a latent space to produce a plurality of vector representations reflective of one or more semantic relationships defined for one or more elements within the unstructured dataset; generate a set of reduced dimension vector representations from the plurality of vector representations by reducing the plurality of vector representations to the set of reduced dimension vector representations associated with one or more global semantic groupings defining one or more top hierarchical semantic relationships identified for the unstructured dataset and one or more local semantic groupings defining one or more sub-hierarchical semantic relationships for each top hierarchical semantic relationships; define one or more clusters for the set of reduced dimension vector representations, each cluster being associated with at least one global semantic grouping of the one or more global semantic groupings, each cluster having one or more sub-clusters with each sub-cluster being associated with at least one local semantic grouping in association with a corresponding global semantic grouping; and generate a dynamic visual representation for the one or more clusters according to a hierarchical structure defined for the unstructured dataset to facilitate the dynamic user engagement with the one or more elements of the unstructured dataset.

In some embodiments, the processor is further operable to receive an engagement input at the dynamic user engagement; automatically adapt the dynamic visual representation in response to the engagement input to vary at least one of: the one or more clusters or one and the more sub-clusters being displayed, a hierarchy level, and a semantic granularity of the dynamic visual representation; and continue to monitor for one or more engagement inputs for varying the dynamic visual representation.

In some embodiments, receiving an engagement input at the dynamic user engagement further comprises operating the processor to receive a user query defining a desired topic; determine a relevance score between the user query and the elements within each cluster; and apply a heat map overlay to highlight clusters based on the relevance score.

In some embodiments, the system further involves automatically labelling each cluster and each sub-cluster using a topic modelling process.

In some embodiments, automatically labeling each cluster using a topic modelling process further comprises dynamically refining cluster labels in response to receiving additional elements.

In some embodiments, defining one or more clusters for the set of reduced dimension vector representations further comprises assigning for the one or more clusters and the one or more sub-clusters a stable orientation such that the relative association between adjacent clusters and adjacent sub-clusters are substantially preserved in response to receiving additional elements.

In some embodiments, in response to receiving additional elements, anchoring additional embedded elements to maintain an overall layout of the dynamic visual representation.

In some embodiments, generating a dynamic visual representation for the one or more clusters according to a hierarchical structure defined for the unstructured data further comprises generating a polygon-based representation for each cluster and each sub-cluster.

In some embodiments, the dynamic user engagement varies based on a user type.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of an example dynamic user engagement in accordance with an example embodiment;

FIG. 2 is a flowchart of an example method of facilitating a dynamic user engagement with an unstructured dataset in accordance with an example embodiment;

FIG. 3A is an example dynamic visual representation in accordance with an example embodiment;

FIG. 3B is the example dynamic visual representation of FIG. 3A at different hierarchy level in accordance with an example embodiment;

FIG. 3C is the example dynamic visual representation of FIG. 3A at different hierarchy level in accordance with an example embodiment;

FIG. 3D is an example dynamic visual representation of FIG. 3A at different hierarchy level in accordance with an example embodiment;

FIG. 4 is a flowchart of another example method of facilitating a dynamic user engagement with an unstructured dataset in accordance with an example embodiment;

FIG. 5 is another example dynamic visual representation in accordance with an example embodiment; and

FIG. 6 is another example dynamic visual representation in accordance with an example embodiment.

The drawings are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

Effective organization and visualization of data can be helpful for users to derive insight and make informed decisions. Organized datasets can help users quickly find the information they are searching for. For example, data can be organized in charts, graphs, or tables to allow users to efficiently analyze trends or understand relationships within the data-particularly, when paired with data manipulation tools such as filtering, sorting, and grouping. These tools can benefit users navigating and analyzing structured datasets with familiar organizational schemes.

It can be challenging for users to engage with datasets, especially when they are just beginning to engage with the dataset(s) and may not have a specific intention with the dataset(s). For example, in the event conference space, event organizers often provide guests with a directory of the various exhibitors (e.g., companies, institutions, or associations). Directories are often provided in advance of the conference (e.g., as a table or list sorted at a basic level (e.g., alphabetically) and/or grouped in categories the event organizers determined appropriate (e.g., by technology sector or geographical location)). Although organizing data in a table or list may be helpful for quickly ordering datasets into a more legible form, it may pose challenges with scalability as the volume and complexity of information increases. When the number of exhibitors on the event list grows too large, this can lead to information overload, making it more difficult for a user to make a decision about which exhibitor they want to visit. Accordingly, a practical presentation of data that is limited to a reasonable scope for a user (until further information is actively requested) can be valuable.

Furthermore, event directories designed by event organizers are usually biased. An event organizer may have their own vision for how a directory should be arranged based on their own perspectives, opinions, and experience. This can limit the universality and navigability of directories, particularly for event attendees that do not share a similar background as is common for community newcomers. In addition, an event directory's effectiveness at communicating the relevance of entities is also limited by the imagination of the designer and their understanding of the directory's users. Accordingly, it is important to organize and present datasets neutrally and objectively.

Although traditional formats of data presentation (e.g., tables and charts) may be sufficient for seasoned attendees (who know what they are searching for), a tabular format may not be conducive for uninitiated attendees that do not have a clear objective or idea of what they are searching for. For such attendees, undirected navigation and search—that is, without specific queries or search terms—for the purpose of information foraging and discovery may be the objective.

Although the above challenges are described using the example of an event conference, it will be understood that these challenges apply to systems that involve engagement and exploratory search with large amounts of data.

In addition, existing solutions for visualizing large datasets for exploratory search include Hilbert-curve layouts, force-directed graphs, grid-based visualizations, and classical hierarchical clustering (e.g., Louvain or frequency-based clustering). These solutions generally require structured or numerical data inputs, limiting their applicability. They often rely on simplistic labeling methods based on feature frequency or manual curation, resulting in unintuitive or biased cluster names. Regular geometric constraints in Hilbert-curve or grid-based layouts inherently distort high-dimensional semantic relationships, misrepresenting true semantic proximity. Furthermore, force-directed layouts lack stability and frequently rearrange dramatically upon incremental data updates, impairing user's ability to develop familiarity

The embodiments disclosed herein directly address these challenges through processing of unstructured data inputs—including text, images, audio, and multimodal combinations—using foundation-model encoders pretrained on internet-scale corpora, thereby creating rich semantic topology. The system employs dimensionality reduction methods designed to preserve semantic topology, hierarchical clustering visualized through polygon-based representations that faithfully reflect semantic groupings, and cluster labels automatically generated via large language model (LLM)-based topic modeling to ensure unbiased and intuitive consensus nomenclature. Additionally, incremental dimensionality reduction techniques maintain stable visual layouts, allowing seamless incorporation of new data without disrupting existing visual familiarity.

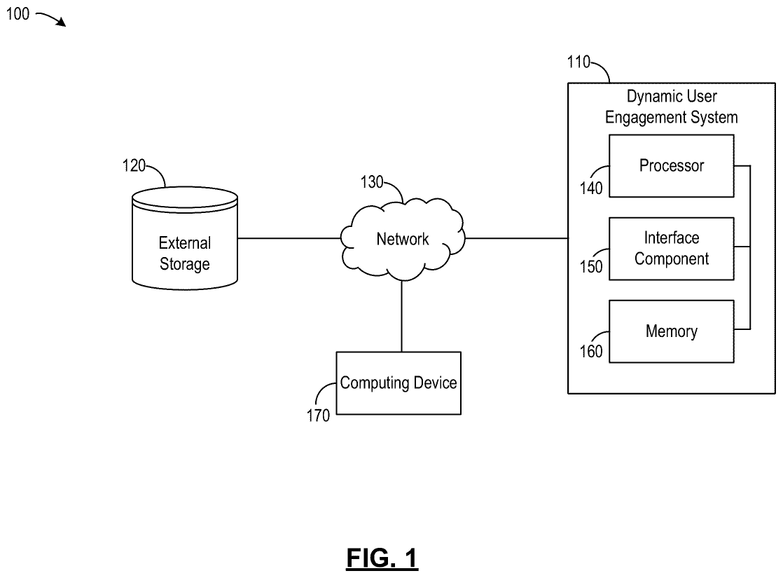

Reference is first made to FIG. 1, which illustrates a block diagram 100 of components interacting with a user engagement 110. The user engagement 110 can receive an unstructured dataset via a network 130, such as via an external storage 120, via a user operating a computing device 170, or other manners. The dynamic user engagement 110 can include various components such as a processor 140, an interface component 150, and a memory 160. It will be understood that the dynamic user engagement 110 can include one or more computer servers that can be distributed over a wide geographic area and connected via the network 130. It will be understood that in some embodiments, each of the processor 140, interface component 150, and memory 160 can be combined into fewer number of components or can be separated into further components. Furthermore, each of the processor 140, interface component 150, and memory 160 can be implemented in software or hardware, or a combination of software and hardware.

The external storage 120 can store information related to the operation of the dynamic user engagement 110. The information stored in the external storage 120 can include, but is not limited to, data that may not be regularly accessed and/or back-up copies of data stored at the memory 160. The external storage 120 can also store structured or unstructured datasets for processing by the processor 140. For the example, in one or both of the memory 160 and the external storage 120 datasets related to, but not limited to, directories, people, content, courses, grants, projects, products, applicants, athletes, ideas, suppliers, restaurants, funding sources, arguments, claims, books, podcasts, principles, quotes, memes, laws, regulations, doctrines, biases, services, features, policies, clauses, resources, agencies, cultural and historical archives, tourist attractions, accommodations, species, hobbies and interests, creators, actors, investments, etc. can be stored for access and use by the dynamic user engagement 110. A dataset may include information related to a collection of entities, or a plurality of groups. In some cases, each group can be further split into one or more subgroups that is associated with a subset of the dataset. In some cases, the dataset may be structured (e.g., an entry in a table of parameters, characteristics, features, or a relational database) or unstructured (e.g., text, images, video, audio, or a composition of data types). The dataset and data subsets can include various different data of different data types.

The network 130 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these, capable of interfacing with, and enabling communication between the dynamic user engagement 110, the external storage 120, and/or the computing device 170. In some embodiments, the network 130 includes a local network and/or local network technologies.

The processor 140 can be configured to control the operation of the dynamic user engagement 110. The processor 140 can be any suitable processor, controller or digital signal processor that can provide sufficient processing power depending on the configuration, purposes and requirements of the dynamic user engagement 110. In some embodiments, the processor 140 can include more than one processing element with each processing element being configured to perform different dedicated tasks. The processor 140 can be positioned at a location separate from the interface component 150 and the memory 160, but in communication with the interface component 150 and/or the memory 160. In some embodiments, the processor 140 can include a processing element coupled to the interface component 150 and/or memory 160, and another processing element physically separate from the other processing element but in communication with each other.

The interface component 150 can be configured to enable the dynamic user engagement 110 to communicate with other devices and systems, such as the external storage 120 and/or the computing device 170. The interface component 150 can include at least one of a serial port, a parallel port or a USB port. The interface component 150 can include at least one of an Internet, Local Area Network (LAN), Ethernet, Firewire, modem or digital subscriber line connection. Various combinations of these elements can be incorporated within the interface component 150. For example, the interface component 150 can receive input from various input devices, such as a mouse, a keyboard, a touch screen, a thumbwheel, a trackpad, a trackball, a card-reader, and the like depending on the requirements and implementation of the dynamic user engagement 110.

The memory 160 can include RAM, ROM, one or more hard drives, one or more flash drives or some other suitable data storage elements such as disk drives, etc. The memory 160 can further include one or more databases (not shown) for storing information relating to the operation of the processor 140, for example. For the example, in one or both of the memory 160 and the external storage 120, data related to, but not limited to, directories, people, content, courses, grants, projects, products, applicants, athletes, ideas, suppliers, restaurants, funding sources, arguments, claims, books, podcasts, principles, quotes, memes, laws, regulations, doctrines, biases, services, features, policies, clauses, resources, agencies, cultural and historical archives, tourist attractions, accommodations, species, hobbies and interests, creators, actors, investments, etc. can be stored for access and use by the dynamic user engagement 110.

The computing device 170 can include any networked device operable to connect to the network 130. A networked device is a device capable of communicating with other devices through a network such as the network 130. A network device may couple to the network 130 through a wired or wireless connection. The computing device 170 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

In operation, the dynamic user engagement 110 can receive a dataset from the external storage 120 over the network 130. The processor 140 may process the dataset, for example, by embedding the dataset into a latent space using foundation model encoders to generate a plurality of vector representations. The processor 140 can apply a topological dimensionality reduction algorithm to the plurality of vector representations to transform them into a lower dimensional space while preserving global and local semantic structures. The processor 140 can perform hierarchical clustering on the reduced dimension vector representations, identify one or more clusters for the reduced dimension vector representations, label each cluster using topic modelling, and present the hierarchical clusters on a graphic user interface provided by the dynamic user engagement 110.

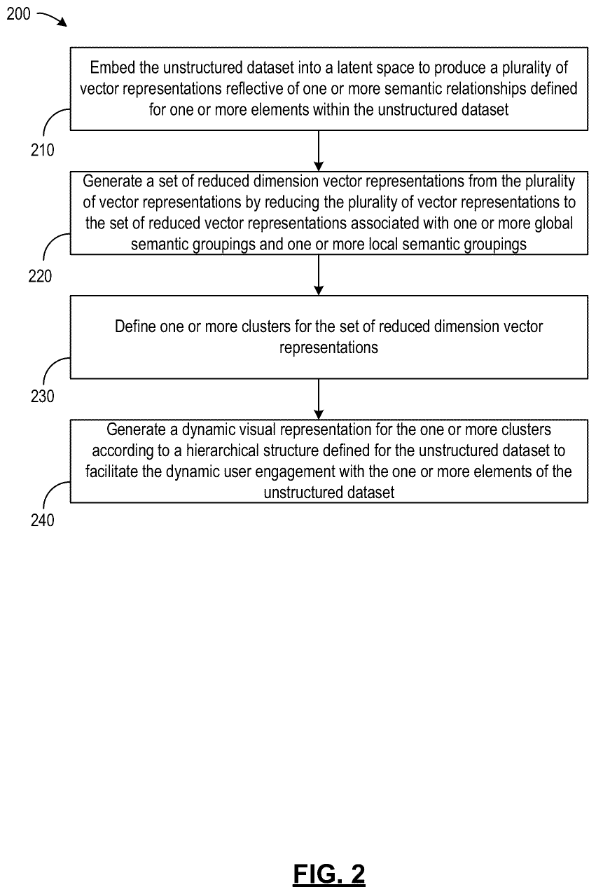

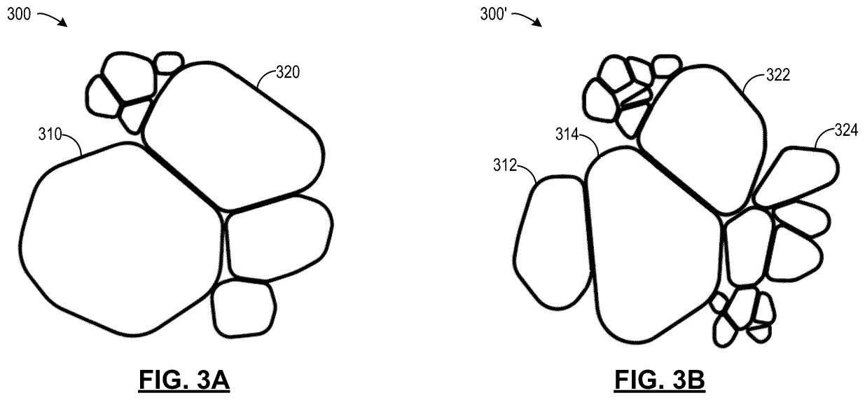

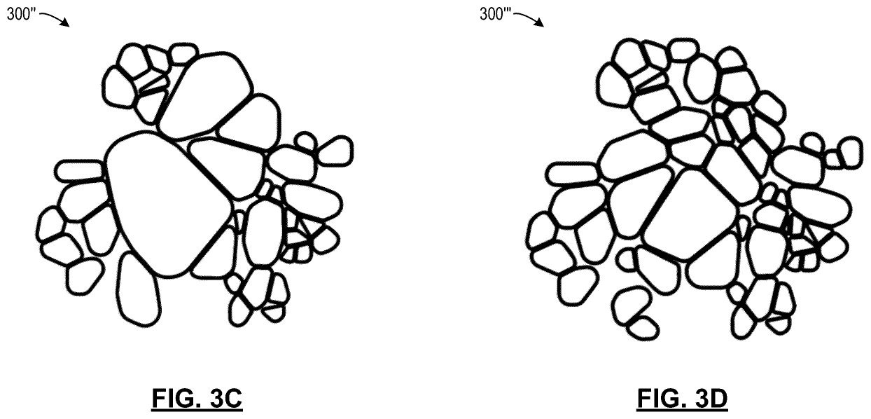

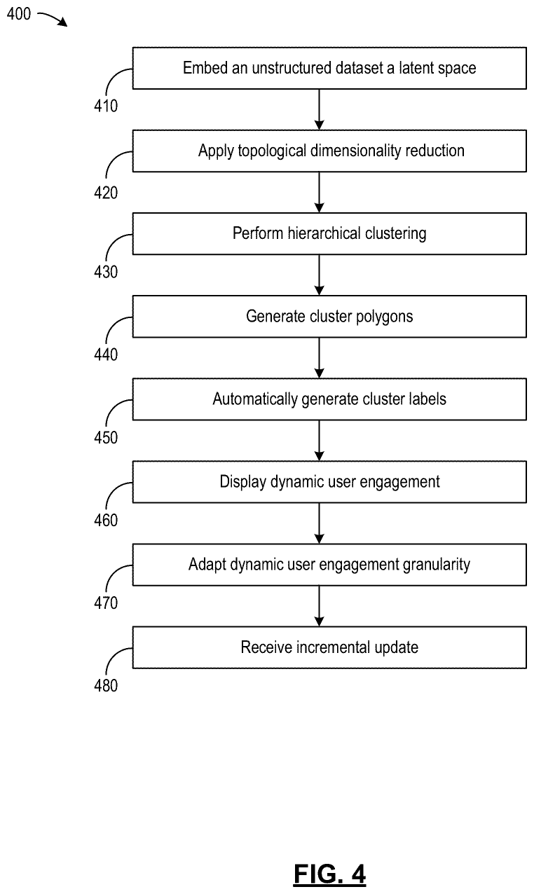

Referring now to FIG. 2, shown therein is a flowchart of an example method 200 of facilitating a dynamic user engagement with an unstructured dataset. To illustrate the method 200, reference will be made to FIG. 3A to FIG. 3D.

At 210, the processor 140 embeds the unstructured dataset into a latent space to produce a plurality of vector representations reflective of one or more semantic relationships defined for one or more elements within the unstructured dataset.

An unstructured dataset can include data that does not adhere to a predefined tabular or relational format. For example, unstructured data can include, but not be limited to, free-form text documents, images, audio files, video files, and/or multimodal combinations thereof. To embed the unstructured dataset into the latent space, the processor 140 may apply foundation-model encoders to derive learned vector relationships. The foundation-model encoder can be, for example, a pretrained artificial neural network utilizing Transformer-based architectures. The foundation-model encoder can be trained on internet scale datasets and capable of transforming the unstructured data into a plurality of vector representations in a high-dimensional semantic latent space. For example, a foundation model-encoder can include Transformer-based language models, multimodal embedding models, and other large-scale neural embedding models.

The latent space can include a plurality of vector representations produced by an artificial neural network embedding. The plurality of vector representations is reflective of one or more semantic relationships defined for one or more of the elements within the unstructured dataspace. In the latent space, proximity between vectors correlates directly to similarity between the semantic relationships of one or more of the underlying data elements. For example, an unstructured dataset related event conference may have data elements representing each event exhibitor. Semantic relationships with high semantic similarity between exhibitors may be identified in the neural network embedding based on various factors such as, for example, the technical space of the exhibitor or the geographical location of the exhibitor. This allows meaningful relationship among diverse data to be quantified and visualized, as described herein.

The plurality of vector representations can be, for example, a numerical vector produced by a foundation model encoder that positions data elements within the latent vector space according to their underlying semantic relationships. The plurality of vector representations organizes elements in the latent space and are characterized by a rich semantic topology, wherein special proximity directly correlates with semantic similarity. This enables quantitative measurement of similarity and difference among diverse, unstructured inputs.

At 220, the processor 140 generates a set of reduced dimension vector representations from the plurality of vector representations by reducing the plurality of vector representations to the set of reduced dimension vector representations associated with one or more global semantic groupings and one or more local semantic groupings. The set of vector representations associated with one or more global semantic groupings can define one or more top hierarchical semantic relationships identified for the unstructured dataset and one or more local semantic groupings defining one or more sub-hierarchical semantic relationships for each top hierarchical semantic relationship.

The set of reduced dimension vector representations can be generated based on the plurality of vector representations using techniques such as topological dimensionality reduction. Topological dimensionality reduction can include a class of dimensionality reduction methods designed specifically to preserve both local neighborhood relationships (or local semantic groupings) and global manifold geometry (or global semantic groupings) of high-dimensional data when represented in lower-dimensional spaces (e.g., two-dimensional (2D) or three-dimensional (3D) coordinates). Examples of topological dimensionality reduction techniques include but are not limited to Uniform Manifold Approximation and Projection (UMAP), t-Distributed Stochastic Neighbor Embedding (t-SNE), Isometric Mapping (Isomap), and related nonlinear manifold learning techniques.

The set of reduced dimension vector representations are generated such that semantic topology (i.e., the intrinsic structural relationships of data points within the higher-dimensional latent space) is preserved. Preserving semantic topology during dimensionality reduction ensures visualizations remain semantically meaningful and intuitively navigable. Each semantic grouping corresponds to a set of one or more of the elements of the unstructured data set.

The set of reduced dimension vector representations can be associated with one or more global semantic groupings. The one or more global semantic groupings can have one or more elements in the unstructured dataset having semantic relationships. The one or more global semantic groupings can define one or more top hierarchical semantic relationships identified for the unstructured dataset. For example, for an unstructured dataset related to an event conference, data elements can correspond to individual exhibitors. One or more exhibitors may be grouped in a global semantic grouping of “Engineering” based on the technical space of each exhibitor within the grouping. Another global semantic grouping, for example, “Technology” may have one or more other exhibitors grouped in another global semantic grouping. The global semantic grouping of “Technology” may be proximally located to the global semantic grouping of “Engineering”. Both the global semantic grouping of “Engineering” and the global semantic grouping of “Technology” may each define a top hierarchical semantic relationship based on having semantic relationships between the exhibitors within each respective global semantic grouping.

The set of vector representations can be associated with one or more local semantic groupings. The one or more local semantic grouping can have one or more elements in the unstructured dataset having semantic relationships. The one or more local semantic groupings can define one or more sub-hierarchical semantic relationships for each top hierarchical semantic relationship. For example, referring to the example of an unstructured dataset related to an event conference, one or more exhibitors may be grouped in a local semantic grouping based on a technical space of each exhibitor within the grouping. One or more exhibitors having a technical field of “Aerospace” may be grouped together in a local semantic grouping and one or more exhibitors in the technical field of “Avionics” may be grouped together in another local semantic grouping. The local semantic grouping related to “Aerospace” and the local semantic grouping related to “Avionics” can have a sub-hierarchical semantic relationship for the top hierarchical semantic relationship defined by the global semantic grouping of “Engineering” due to having semantic similarity within the technical space of engineering.

At 230, the processor 140 defines one or more clusters for the set of reduced dimension vector representations. Each cluster can be associated with at least one global semantic grouping of the one or more global semantic groupings. At least one cluster can have one or more sub-clusters with each sub-cluster being associated with at least one local semantic grouping in association with a corresponding global semantic grouping. In some cases, clusters are not further divided into sub-clusters. For example, clusters at the lowest hierarchical level (i.e., the highest granularity) are not divided into sub-clusters.

Clusters can be identified from the set of reduced dimension vector representations using hierarchical clustering approaches. Hierarchical clustering approaches produce nested cluster structures wherein clusters at lower granularity are subdivided into progressively smaller sub-clusters at higher granularities. This allows for exploration from broad global semantic groupings down to fine-grained local semantic groupings. For example, clusters corresponding to a global semantic grouping can be at a higher hierarchy level and can have one or more sub-clusters corresponding to local semantic groupings defined at a lower hierarchy level. Hierarchical clustering methods include, for example, Agglomerative Clustering, Divisive Clustering, Hierarchical Density-Based Spatial Clustering of Applications with Noise (HDBSCAN), and similar hierarchical clustering algorithms.

Referring now to FIGS. 3A and 3B, shown therein is a dynamic visual representation 300, and dynamic visual representation 300′, which shows dynamic visual representation 300 at a different hierarchical level. As shown in FIG. 3A, the dynamic visual representation 300 can include polygon-based representations for each cluster, such as clusters 310, 320. Clusters 310, 320, shown in FIG. 3A may correspond to global semantic groupings. As shown in FIG. 3B, each cluster, 310, 320 can be further divided into sub-clusters corresponding to local semantic groupings, such as sub-clusters 312 and 314 of cluster 310 and sub-clusters 322 and 324 of cluster 320.

In some embodiments, the processor 140 automatically labels each cluster using a topic modelling process. Topic modelling processes can use large language models (LLM), such as Transformer-based neural networks pretrained on extensive textual corpora, to generate semantically meaningful and intuitive labels for data clusters. These labels align closely with consensus nomenclature commonly understood by diverse user communities, reducing subjective biases inherent in frequency-based or manually curated labels. Generating hierarchical labels through LLM-based topic modeling facilitates more intuitive and semantically representative group names. By leveraging large-scale pretrained models (e.g., GPT-like architectures), the labelling process aligns with widely used, consensus-driven terminology. This reduces subjective bias and produces cluster labels that resonate with the broadest possible set of users. In some embodiments, LLM-based topic modelling processes can include generating cluster labels by inferring semantic descriptors that minimize bias and fragility due to raw frequency-based methods. In some embodiments, cluster labels may include images, videos, patterns, symbols, and representative cluster entity samples that can be generated by the processor 140 using generative artificial neural networks including diffusion models.

In some embodiments, automatically labelling each cluster using a topic modelling process includes dynamically refining cluster labels in response to receiving additional elements. The processor 140 may receive additional elements to add to the dynamic user engagement 110. For example, an unstructured dataset related to an event conference may have elements corresponding to the exhibitors at the event conference. In this case, additional elements received by the processor 140 can include additional exhibitors that were not included in the initial unstructured dataset. In response to receiving additional elements, the processor 140 can be refine cluster labels to more aptly describe the cluster of the dynamic user engagement 110. For example, the processor 140 may automatically label a cluster related to “Science” based on the technical field of the exhibitors within the cluster, for the initial unstructured dataset. The processor 140 may receive additional elements such as additional exhibitors. The processor 140 may identify semantic relationships between one or more additional elements and the one or more elements within the existing cluster and add the additional elements to the semantic grouping (i.e., global or local) corresponding to the existing cluster. In addition, the processor 140 may then refine the cluster label “Science” based on the technical field of the additional elements. For example, if the additional elements include exhibitors related to the technical field of engineering, the processor 140 may refine the cluster label to “Science and Engineering”.

In some embodiments, elements may include information relevant to the entity. In some cases, the arrangement of elements may be static or dynamic. The elements include content (e.g., titles, text, images, logos, videos, portraits, flags, gauges, animations, etc.) and hyperlinks. These elements may be an interactive interface, game, or portal.

The hierarchical structure can be defined by clusters representing different levels of granularity of the unstructured data. In general, a cluster corresponding to a global semantic grouping will have a lower level of granularity as compared to a sub-cluster corresponding to a local semantic grouping. For example, a cluster corresponding to global semantic grouping may have a cluster label “Technology” and be associated with a top hierarchy level (or a first hierarchy level). Sub-clusters corresponding to local semantic groupings may have sub-cluster labels “Biotechnology” and “Data Science” and can be associated with a second hierarchy level (i.e., a sub-hierarchy level).

In some embodiments, sub-clusters corresponding to local semantic groupings associated with a second hierarchy level can be directly related to a cluster corresponding to a global semantic grouping associated with a first hierarchy level within the defined hierarchical structure. For example, sub-clusters labelled “Biotechnology”, and “Data Science” associated with the second hierarchy level may be related to the cluster “Technology” associated with the first hierarchy level.

In some embodiments, defining one or more clusters for the set of reduced dimension vector representations includes assigning a stable orientation for the one or more clusters and the one or more sub-clusters such that the relative association between adjacent clusters and adjacent sub-clusters are substantially preserved in response to receiving additional elements.

Additional elements can be incrementally incorporated by the processor 140 to maintain visual stability. The processor 140 may use foundation-model embeddings trained on extensive internet-scale data and incremental dimensionality reduction methods, such as parametric Uniform Manifold Approximation and Projection (UMAP), newly introduced elements are smoothly integrated into the existing visualization. This process ensures that the overall semantic topology and relative positioning of existing clusters remain consistent. This can reduce cognitive friction for users who repeatedly engage with dynamically updated visualizations.

In some embodiments, in response to receiving additional unstructured data, the processor 140 anchors additional embedded elements to maintain an overall layout of the dynamic visual representation. Maintaining the overall layout preserves the visual stability of the dynamic user engagement 110 by ensuring a consistent orientation and positioning of the dynamic visual representations. For example, in response to receiving additional elements, incremental dimensionality reduction techniques and stable polygon adaptations are implemented to ensure visual stability.

At 240, the processor 140 generates a dynamic visual representation for each cluster according to the hierarchical structure to facilitate the dynamic user engagement 110 with one or more elements of the set of reduced dimension vector representations.

Dynamic visual representations define the bounds of the elements within each cluster or each sub-cluster for its respective semantic grouping.

In some embodiments, generating a dynamic visual representation for the one or more clusters according to a hierarchical structure defined for the unstructured data includes generating a polygon-based representation for each cluster and each sub-cluster.

A polygon-based representation can be defined as a graphical depiction of each cluster in which the boundaries encapsulating a cluster's elements are represented as polygons. Polygons can be computed by applying boundary detection algorithms such as for example, but not limited to, Convex Hull, Concave Alpha Hull (alpha shapes), Voronoi diagrams, or related geometric methods. These polygons visually reflect the true spatial extents of clusters within the reduced-dimensional embedding space and can be post-processed for smoothness, aesthetic clarity, and stability. The transparency of the polygons within the dynamic user engagement can vary. For example, the polygons can be filled with a solid color that is representative of the associated cluster's position within the overall embedding space. In another example, the polygons can be colored based on relevance to a search query received from an engagement input.

In some embodiments, the processor 140 receives an engagement input at the dynamic user engagement 110. Examples of engagement input can include, but are not limited to, zooming, panning, scrolling, clicking, double-tapping, pinch-to-zoom gestures, touch gestures, voice commands, and natural-language search inputs. In response to receiving an engagement input, the processor 140 automatically adapts the dynamic visual representation. An engagement input can vary at least one of one or more clusters being displayed, the hierarchy level, and a semantic granularity of the dynamic visual representation. For example, engagement inputs can vary the dynamic visual representation to navigate through various hierarchical layers of the dynamic visual representation (i.e., traversing layers using the zoom function). This can ensure that the dynamic visual representation reveals a tiered amount of information, which increases in granularity in response to a request/engagement from the user. For example, zooming in on the dynamic user engagement 110 can enable more detail in the dynamic visual representation to be illustrated, such as by drilling down on each cluster further and increasing the granularity of the elements presently shown. In contrast, zooming out can hide details by merging various groups shown and reduce the granularity of the shown clusters. The processor 140 continues to monitor for one or more engagement inputs for varying the dynamic visual representation.

In some embodiments, transitions between layers of the hierarchical structure can be abrupt or animated. There may be additional interaction functions for hiding layers, filtering entities, semantic search, search query relevance heat-map overlay or cluster/entity icon recovering, reconfiguring the embedding or the clusters through rotation scaling distortion, etc.

In some embodiments, the dynamic user engagement 110 can provide a semantic search tool. Via the semantic search tool, the dynamic user engagement 110 can receive a search query from a user to initiate a semantic search process. The search query defines a single dimension of relevance within the high-dimensional vector space. The processor 140 may process the user's natural language query using an artificial neural network into vector representations. This processing may be performed by an artificial neural network's encoder(s) and the vector representation may be a deep feature vector, a latent vector, or an embedding. The artificial neural network may be unimodal or multi-modal. The resulting vector representations may be quantized for reduced memory usage.

The vector representations may be compared with the vector representation corresponding with the user's query. This comparison may be performed using distance metrics such as, but not limited to, Euclidean Distance, Manhattan Distance, Cosine Similarity, Hamming Distance, and Minkowski Distance. These distance metrics may be mapped to a similarity and relevance score (the higher the score, the more relevant/similar; the lower the score, the less relevant/similar). The distance measured can be inversely proportional to the similarity and relevance score in this case. The similarity and relevance score may be used to apply an intensity map (or heat-map overlay) to the groups shown on the dynamic visualization so that the relevance of each group to the search query is visually shown to be color-coded according to a heatmap intensity.

In some embodiments, receiving an engagement input at the dynamic user engagement includes receiving a user query defining a desired topic. For example, the user may provide an engagement input (e.g., via a search bar). The processor 140 determines a relevance score between the user query and the elements within each cluster. For example, the processor 140 may use semantic tokenization to identify elements within each cluster that are related to the user query and determine a relevance score for each element. The processor 140 can apply a heat map to highlight clusters based on the relevance score. For example, clusters containing elements with high relevance scores can be highlighted to the user. In some embodiments, different levels of highlighting can be used depending on the relevance score. For example, clusters having many elements related to the user query or clusters having elements with a higher relevance score can be highlighted more prominently.

In some embodiments, the dynamic user engagement varies based on a user type. For example, the dynamic user engagement 110 may include different clusters and different sub-clusters from the same unstructured dataset for different users based on user preferences or requirements.

Referring now to FIGS. 3A to 3D, shown therein is a dynamic visual representation 300, and dynamic visual representations 300′, 300″, 300″ which show dynamic visual representation 300 at different hierarchical levels.

The processor 140 can generate the dynamic visual representation 300 such that clusters that are semantically similar are relatively positioned. For example, clusters 310, 320 corresponding to global semantic groupings are positioned proximately as they are semantically similar. Sub-clusters 312, 324 corresponding to respective local semantic groupings are positioned distantly as they are not semantically similar.

When the dynamic user engagement 110 receives an engagement input from a user, the dynamic visual representation 300 can automatically adapt in response to vary at least one of, one or more of the clusters 310, 320 and one or more sub-clusters 312, 314, 322, 324 being displayed, the hierarchy level, and a granularity level of the dynamic visual representation 300.

For example, as between each of FIGS. 3A to 3D, it can be seen that the clusters 310, 320 corresponding to global semantic groupings are shown at various levels of granularity. FIG. 3A shows the dynamic visual representation 300 at a first hierarchy level (e.g., highest level of abstraction), whereas each of FIGS. 3B to 3D show deeper hierarchy levels of the unstructured dataset (e.g., lower levels of abstraction). The dynamic visual representation 300 starts at the first hierarchy level. As the dynamic user engagement receives engagement inputs from the user, the dynamic visual representation 300 can adapt accordingly. FIG. 3B shows the dynamic visual representation 300 of FIG. 3A, but at a second hierarchy level (i.e., a sub-hierarchical level) now corresponding to dynamic visual representation 300′, after receiving an engagement input at the dynamic user engagement from a user. For example, the engagement input may include a gesture to increase the granularity of the dynamic visual representation 300 (e.g., to display sub-clusters 312, 314, 322, 324 corresponding to respective local semantic groupings). In response to receiving the engagement input, a more granular view dynamic visual representation 300 is shown via dynamic visual representation 300′.

Similarly, FIGS. 3C and 3D show the respective dynamic visual representations 300″ and 300″ with further levels of granularity (i.e., a third and a fourth hierarchy level, respectively) in response to receiving an engagement input at the dynamic user engagement corresponding to drilling further into the data. Although four different hierarchy levels are shown herein, it will be understood that fewer or more hierarchy levels may be used, depending on the dataset and/or user requirements. In general, when received, the processor 140 interprets the engagement input(s) to determine how to vary the dynamic visual representation 300 accordingly. For example, a user may provide an engagement input to zoom into the dynamic visual representation 300 to navigate to more granular hierarchy levels, such as 300′ to 300″, or may provide an engagement input to zoom out of the dynamic visual representation 300′ to navigate to less granular hierarchy levels, such as shown in dynamic visual representation 300.

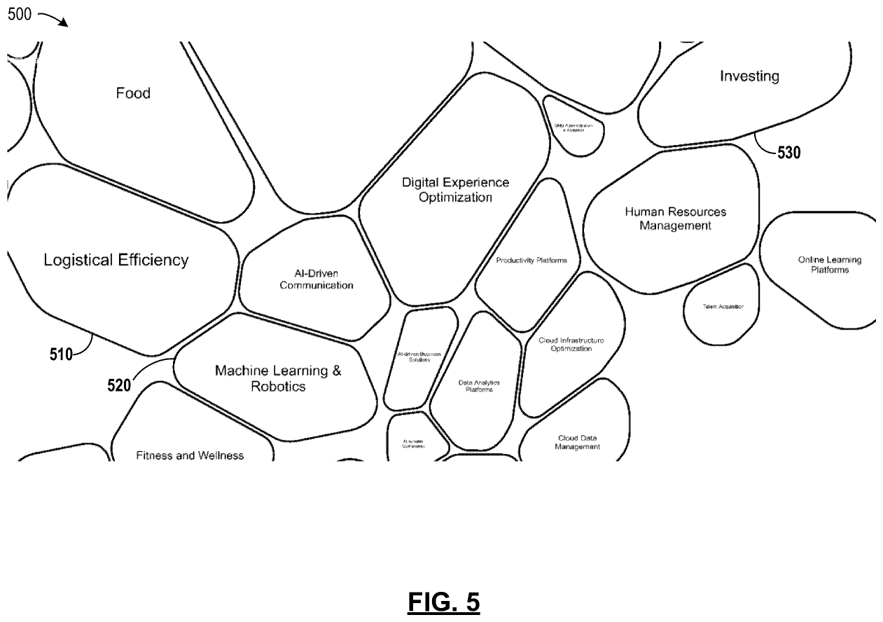

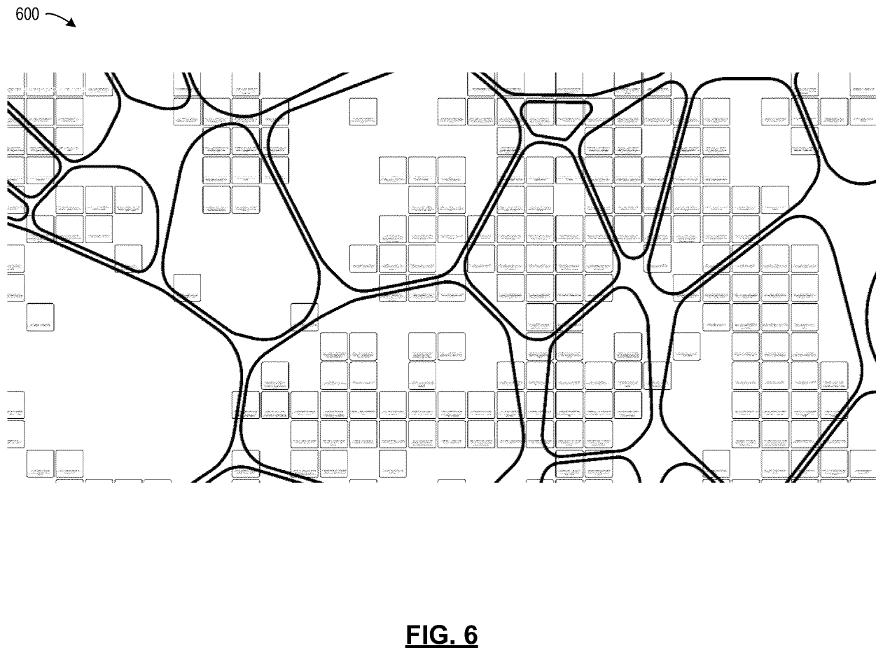

Referring to FIG. 4, shown therein is a flowchart of an example method 400 of facilitating a dynamic user engagement with an unstructured dataset in accordance with an example embodiment. To illustrate the method 400, reference will be made to FIG. 5 and FIG. 6 and described using an example unstructured dataset related to exhibitors at an event conference.

At 410, the processor 140 embeds an unstructured dataset into a latent space using a foundation-model encoder such as a Transformer-based neural network pretrained on internet scale data. The unstructured dataset can include text, images, audio, multimodal data, and/or any combination of these. For example, the unstructured dataset can include elements such as exhibitors at the event conference and can include text related to the names of the exhibitors, images related to logos or icons associated with the exhibitors, or promotional video footage associated with the exhibitors.

At 420, the processor 140 applies topological dimensionality reduction algorithm such as UMAP or t-SNE to generate a set of reduced dimension vector representations while preserving local and global semantic topology. After applying the topological dimensionality reduction algorithm, the unstructured dataset can is grouped in local and global semantic groupings. For example, exhibitors related to “Exercise” can be grouped in a local semantic grouping and exhibitors related “Nutrition” to can be grouped in another local semantic grouping. Both exhibitors can also be grouped in the global semantic grouping of “Health”.

At 430, the processor 140 performs hierarchical clustering on the set of reduced dimension vector representations to identify semantic groups of clusters. Semantic groups of clusters can be defined in a hierarchical structure using techniques such as HDBSCAN or agglomerative clustering. Global semantic groupings can be associated with a higher hierarchy level (i.e., lower semantic granularity) and local semantic groupings can be associated with a lower hierarchy level (i.e., higher semantic granularity). For example, local semantic groupings for “Nutrition” and “Exercise” can be associated with a hierarchy level lower than the global semantic grouping of “Health”.

At 440, the processor 140 generates a polygon-based representation for each cluster to visually enclose the elements within each cluster. These elements can be bounded by the polygon-based representation to visually indicate all the elements are of the same cluster. For example, one or more exhibitors related to exercise can be constituent elements within a polygon representing a cluster related to the local semantic grouping of “Exercise”. In addition, one or more exhibitors related to exercise or nutrition can be constituent elements within a polygon representing a cluster related to the global semantic grouping of “Health”.

At 450, the processor 140 automatically generates cluster labels for each cluster using an LLM-based topic modelling approach to ensure semantically meaningful and unbiased naming for each cluster.

At 460, the processor 140 displays a dynamic visual representation of the dynamic user engagement. For example, a dynamic visual representation 500 shown in FIG. 5 can display the polygon-based representation of clusters at a higher abstraction level. The clusters 510, 520, 530 shown in FIG. 5 can be relatively positioned based on similarity. For example, cluster 510 labelled “Logistical Efficiency” and cluster 520 labelled “Machine Learning & Robotics” may be semantically similar and are positioned in close proximity. In contrast, cluster 530 labelled “Investing” is not semantically similar when compared with cluster 510 and cluster 520, and is positioned further away accordingly.

At 470, the processor 140 adapts the dynamic user engagement. The processor 140 can adapt the dynamic visual representation in response to an engagement input at the dynamic user engagement. For example, the processor 140 can receive an engagement input such as a zooming gesture. In response the dynamic visual representation can adapt to show a hierarchy level of increased semantic granularity, such as the dynamic visual representation 600 shown in FIG. 6. As shown in FIG. 6, the base level (i.e., the most granular level) shows the elements of the unstructured dataset. For example, the base level may include individual entities represented within the dataset, such as individual exhibitors at an event conference.

At 470, the processor 140 receives incremental updates such as additional elements to be added to the unstructured dataset. In response, the processor 140 incrementally updates the dynamic user engagement with the additional elements while maintaining stable polygon layouts at the dynamic visual representation to preserve user orientation. For example, additional elements can include additional exhibitors related to the local semantic grouping of “Exercise”. Accordingly, the additional exhibitors are added to the cluster defined by the polygon labelled “Exercise” such that the overall layout and visual stability of the dynamic visual representation is preserved.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

Various embodiments have been described herein by way of example only. Various modifications and variations may be made to these example embodiments without departing from the spirit and scope of the invention, which is limited only by the appended claims.

1. A method of facilitating a dynamic user engagement with an unstructured dataset, the method comprising operating a processor to:
embed the unstructured dataset into a latent space to produce a plurality of vector representations reflective of one or more semantic relationships defined for one or more elements within the unstructured dataset;
generate a set of reduced dimension vector representations from the plurality of vector representations by reducing the plurality of vector representations to the set of reduced dimension vector representations associated with one or more global semantic groupings defining one or more top hierarchical semantic relationships identified for the unstructured dataset and one or more local semantic groupings defining one or more sub-hierarchical semantic relationships for each top hierarchical semantic relationships;
define one or more clusters for the set of reduced dimension vector representations, each cluster being associated with at least one global semantic grouping of the one or more global semantic groupings, at least one cluster having one or more sub-clusters with each sub-cluster being associated with at least one local semantic grouping in association with a corresponding global semantic grouping; and
generate a dynamic visual representation for the one or more clusters according to a hierarchical structure defined for the unstructured dataset to facilitate the dynamic user engagement with the one or more elements of the unstructured dataset.

2. The method of claim 1, further comprising operating the processor to:
receive an engagement input at the dynamic user engagement;
automatically adapt the dynamic visual representation in response to the engagement input to vary at least one of:
the one or more clusters and the one or more sub-clusters being displayed,
a hierarchy level, and
a semantic granularity of the dynamic visual representation; and
continue to monitor for one or more engagement inputs for varying the dynamic visual representation.

3. The method of claim 2, wherein receiving an engagement input at the dynamic user engagement further comprises operating the processor to:
receive a user query defining a desired topic;
determine a relevance score between the user query and the elements within each cluster; and
apply a heat map overlay to highlight clusters based on the relevance score.

4. The method of claim 1, further comprising automatically labelling each cluster and each sub-cluster using a topic modelling process.

5. The method of claim 4, wherein automatically labeling each cluster using a topic modelling process further comprises dynamically refining cluster labels in response to receiving additional elements.

6. The method of claim 1, wherein defining one or more clusters for the set of reduced dimension vector representations further comprises assigning for the one or more clusters and the one or more sub-clusters a stable orientation such that the relative association between adjacent clusters and adjacent sub-clusters are substantially preserved in response to receiving additional elements.

7. The method of claim 6, wherein in response to receiving additional elements, anchoring additional embedded elements to maintain an overall layout of the dynamic visual representation.

8. The method claim 1, wherein generating a dynamic visual representation for the one or more clusters according to a hierarchical structure defined for the unstructured data further comprises generating a polygon-based representation for each cluster and each sub-cluster.

9. The method of claim 1, wherein the dynamic user engagement varies based on a user type.

10. A system of facilitating a dynamic user engagement with an unstructured dataset, the system comprising a processor operable to:
embed the unstructured dataset into a latent space to produce a plurality of vector representations reflective of one or more semantic relationships defined for one or more elements within the unstructured dataset;
generate a set of reduced dimension vector representations from the plurality of vector representations by reducing the plurality of vector representations to the set of reduced dimension vector representations associated with one or more global semantic groupings defining one or more top hierarchical semantic relationships identified for the unstructured dataset and one or more local semantic groupings defining one or more sub-hierarchical semantic relationships for each top hierarchical semantic relationships;
define one or more clusters for the set of reduced dimension vector representations, each cluster being associated with at least one global semantic grouping of the one or more global semantic groupings, at least one cluster having one or more sub-clusters with each sub-cluster being associated with at least one local semantic grouping in association with a corresponding global semantic grouping; and
generate a dynamic visual representation for the one or more clusters according to a hierarchical structure defined for the unstructured dataset to facilitate the dynamic user engagement with the one or more elements of the unstructured dataset.

11. The system of claim 10, wherein the processor is further operable to:
receive an engagement input at the dynamic user engagement;
automatically adapt the dynamic visual representation in response to the engagement input to vary at least one of:
the one or more clusters and the one or more sub-clusters being displayed,
a hierarchy level, and
a semantic granularity of the dynamic visual representation; and
continue to monitor for one or more engagement inputs for varying the dynamic visual representation.

12. The system of claim 11, wherein receiving an engagement input at the dynamic user engagement further comprises operating the processor to:
receive a user query defining a desired topic;
determine a relevance score between the user query and the elements within each cluster; and
apply a heat map overlay to highlight clusters based on the relevance score.

13. The system of claim 10, wherein the processor is further operable to automatically label each cluster and each sub-cluster using a topic modelling process.

14. The system of claim 13, wherein operating the processor to automatically label each cluster and each sub-cluster using a topic modelling process further comprises dynamically refining cluster labels in response to receiving additional elements.

15. The system of claim 10, wherein operating the processor to define one or more clusters for the set of reduced dimension vector representations further comprises assigning for the one or more clusters and the one or more sub-clusters a stable orientation such that the relative association between adjacent clusters and adjacent sub-clusters are substantially preserved in response to receiving additional elements.

16. The system of claim 15, wherein in response to receiving additional elements, the processor is further operable to anchor additional embedded elements to maintain an overall layout of the dynamic visual representation.

17. The system of claim 10, wherein operating the processor to generating a dynamic visual representation for the one or more clusters according to a hierarchical structure defined for the unstructured data further comprises generating a polygon-based representation for each cluster and each sub-cluster.

18. The system of claim 10, wherein the dynamic user engagement varies based on a user type.
